(19) United States
(12) Patent Application Publication
(10) Pub. No.: US 2019/0101428 A1
(43) Pub. Date: Apr. 4, 2019

(54) WATER LEVEL MONITORING SYSTEM

(71) Applicants: Chun-Ming Huang, Hsinchu City (TW); Chen-Chia Chen, Hsinchu City (TW); Chien-Ming Wu, Hsinchu City (TW)

(72) Inventors: Chun-Ming Huang, Hsinchu City (TW); Chen-Chia Chen, Hsinchu City (TW); Chien-Ming Wu, Hsinchu City (TW)

(73) Assignee: National Applied Research Laboratories, Hsinchu City (TW)

(21) Appl. No.: 15/821,837

(22) Filed: Nov. 23, 2017

(30) Foreign Application Priority Data
Sep. 29, 2017 (TW) 106133561

(51) Int. Cl. G01F 23/00

(52) U.S. Cl. CPC G01F 23/0038

(57) ABSTRACT

A water level monitoring system includes at least one floating unit, a load cell and a sensor module. The floating unit is used for sinking in water. The load cell is connected to the floating unit for generating a force value reflecting buoyancy generating from the floating unit entering the water. The sensor module is connected to the load cell for sensing the force value from the load cell and includes an amplifier for amplifying a sensed value. A processor connected to the amplifier receives the sensed value from the amplifier and calculating a water level depth to be measured. Thus the water level motoring system has features of low cost, high stability and flexibility.

### BACKGROUND OF THE INVENTION

### 1. Technical Field

The invention relates to water level gauges, particularly to a water level monitoring system which uses buoyancy to calculate water level depth.

### 2. Related Art

In recent years, due to global warming and extreme weather, heavy rain occurs more and more frequently and seriously. This usually causes disaster of floods.

To increase an effect of early warning, systems of early warning for flood are built by the governments for warning people to prevent disaster. These systems are usually disposed at embankments or water gates. However, some floods in urban areas are irrelated to the water depth information in those places. Therefore, quantity and location of disposition of the water level gauges are a key component to improve the definition and accuracy of the systems.

Conventional water level gauges can be roughly divided into two kinds, namely, non-contact type and contact type. The non-contact type, such as an ultrasonic water level gauge and radar water level gauge, is more reliable than the contact type because the former does not require touching water. However, the non-contact type is easy to be affected by the environment because of physical limitations and is relatively expensive. The contact type is cheaper than the non-contact type, but its sensing mechanism is easy to be damaged due to collision with foreign matter in water. In other words, two existing types of water level gauges are not good enough. This is a problem to be solved.

### SUMMARY OF THE INVENTION

An object of the invention is to provide a water level monitoring system, which utilizes modularization and series connection to extend a measurable range and to overcome the inherent problem of the contact type. As a result, the invention can implement a monitoring system with continuity and individual monitor.

To accomplish the above object, the water level monitoring system of the invention includes at least one floating unit, a load cell and a sensor module. The floating unit is used for sinking in water. The load cell is connected to the floating unit for generating a force value reflecting buoyancy generating from the floating unit entering the water. The sensor module is connected to the load cell for sensing the force value from the load cell and includes an amplifier for amplifying a sensed value. A processor connected to the amplifier receives the sensed value from the amplifier and calculating a water level depth to be measured.

### BRIEF DESCRIPTION OF THE DRAWINGS

FIG. 1 is a schematic view of structure of the invention;

FIG. 2 is a block diagram of circuit of the invention;

FIG. 3 is a schematic view of operation of the invention;

FIG. 4 is a block diagram of circuit of the second embodiment of the invention;

FIG. 5 is a schematic view of structure of the third embodiment of the invention; and

FIG. 6 is a block diagram of the sensor module of the invention.

### DETAILED DESCRIPTION OF THE INVENTION

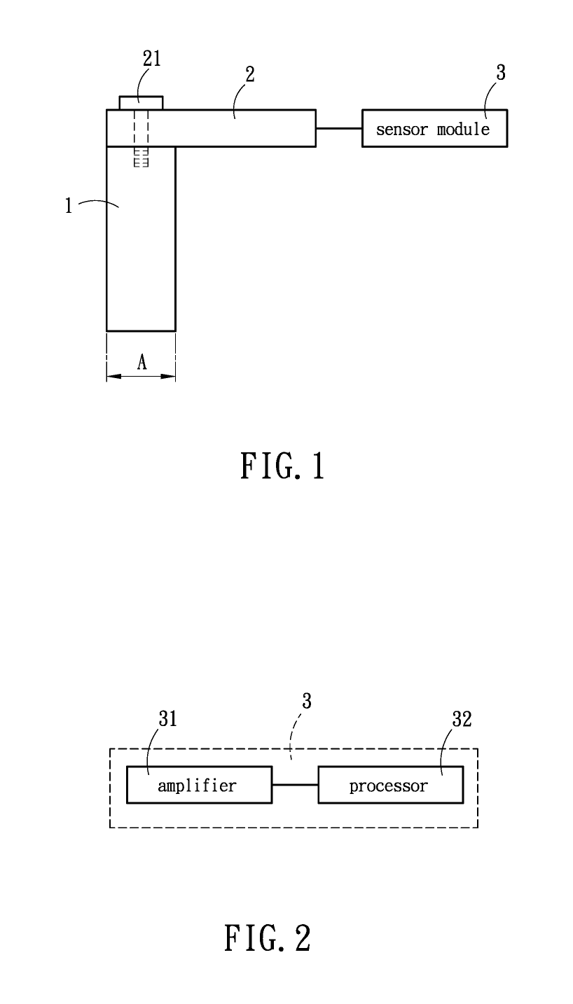

Please refer to FIG. 1, which is a schematic view of structure of the invention. As shown, the water level monitoring system of the invention includes at least one floating unit 1, a load cell 2 and a sensor module 3. The floating unit 1 is used to be put in water to be measured. The floating unit 1 has a certain length and a certain bottom area A for generating buoyancy when being put in water. The load cell 2 is connected to the floating unit 1. In this embodiment, the load cell 2 is disposed atop the floating unit 1. The load cell 2 can be fixed on the floating unit 1 by screws 21 as shown in FIG. 1 or an interlocking manner. The load cell 2 is used for bearing the buoyancy from the floating unit 1 and correspondingly generating a force value.

The sensor module 3 is connected to the load cell 2 for generating value signals by a sensing manner. The sensor module 3 is used for sensing the buoyancy value from the load cell 2 by which a water level can be calculated.

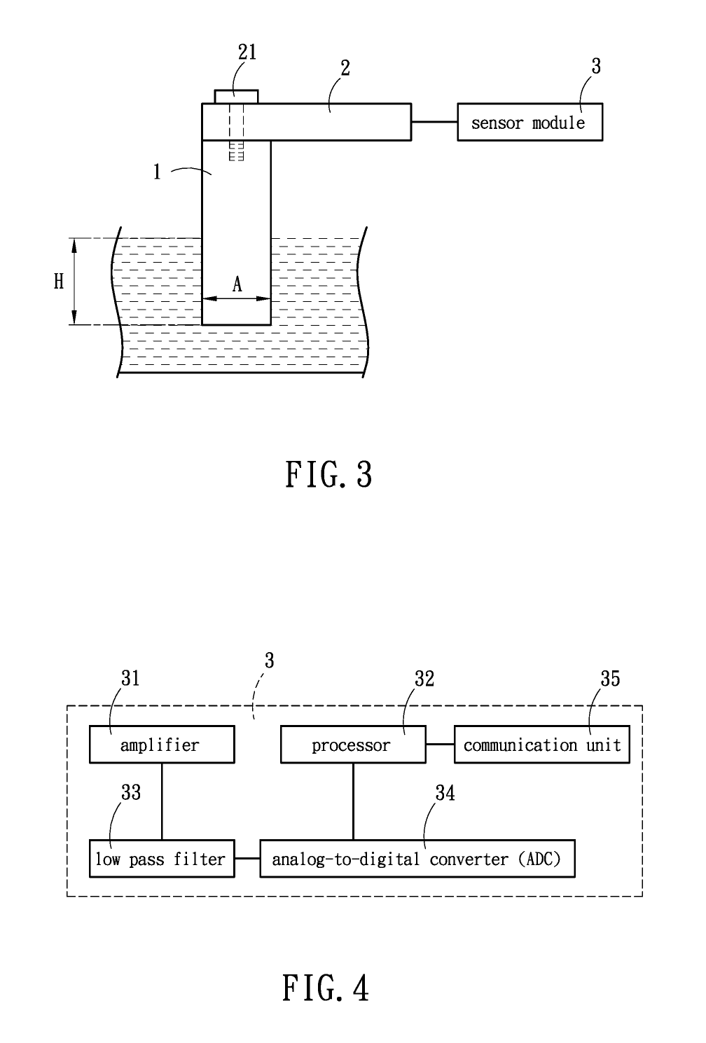

Please refer to FIG. 2. The sensor module 3 includes an amplifier 31 and a processor 32. The amplifier is electrically connected to the processor 32 for amplifying the buoyancy value from the load cell 2 and then sending to the processor 32. The processor 32 may be a microprocessor 32. As shown in FIG. 3, the floating unit 1 is sunk in water to generate buoyancy. The buoyancy is transferred to the load cell 2 to be amplified by the amplifier 31 and then to be calculated by the processor 32. Because the bottom area A of the floating unit 1 is fixed, according the buoyancy formula F=ρAH, where ρ is a density of water, the relationship between buoyancy and water depth H is linear. As a result, the water depth H can be obtained by the buoyancy value.

Please refer to FIG. 4, which is a block diagram of circuit of the second embodiment of the invention. As shown, the sensor module 3 includes a low pass filter 33 and an analog-to-digital converter (ADC) 34. The analog-to-digital converter 34 is electrically connected to the low pass filter 33. The low pass filter 33 is used for filtering the sensed value from the amplifier 31 to reduce noise. The ADC 34 is electrically connected between the low pass filter 33 and the processor 32 for converting the sensed value from the low pass filter 33 into a digital format and then sending back to the processor 32 for further calculation. In addition, the processor 32 is further electrically connected to a communication unit 35 through which the processor 32 can transmit its sensing information to an external system via network for remote control and sequential analysis.

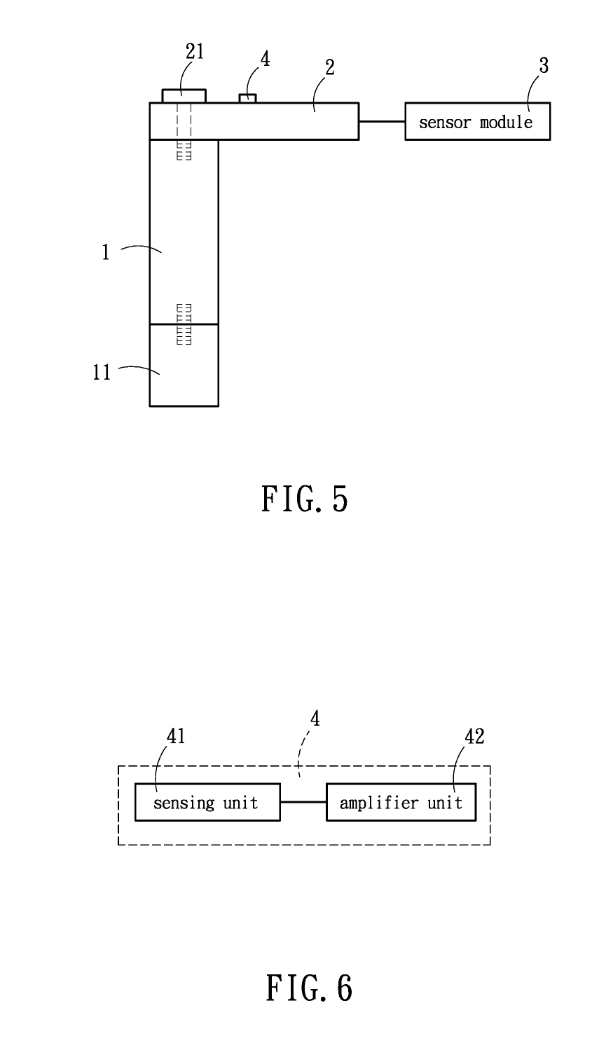

Please refer to FIG. 5, which is a schematic view of structure of the third embodiment of the invention. As shown, a temperature sensing module 4 is disposed on the load cell 2. The temperature sensing module 4 includes a sensing unit 41 and an amplifier unit 42. As shown in FIG. 6, the sensing unit 41 is electrically connected to the amplifier unit 42. The temperature sensing module 4 is electrically connected to the sensor module 3. The sensing unit 41 is used for sensing an environmental temperature and a temperature of the load cell 2 and sending the sensed temperature values amplified by the amplifier unit 42 back to the processor 32 of the sensor module 3. As a result, the sensed values of the load cell 2, which are affected by temperature, can be corrected. In this embodiment, the sensing unit 41 is a temperature detector. Additionally, the floating unit 1 can be added with a first floater 11 for extending length of the whole floater. This can satisfy different requirements under various measuring environments under a lower cost of the floating unit 1.

It will be appreciated by persons skilled in the art that the above embodiments have been described by way of example only and not in any limitative sense, and that various alterations and modifications are possible without departure from the scope of the disclosed example as defined by the appended claims.

What is claimed is:

1. A water level monitoring system comprising:
at least one floating unit for sinking in water;
a load cell, connected to the floating unit for generating a force value reflecting a buoyancy generating from the floating unit entering the water; and
a sensor module, connected to the load cell for sensing the force value from the load cell, and comprising:
an amplifier for amplifying a sensed value; and
a processor, connected to the amplifier for receiving the sensed value from the amplifier and calculating a water level depth to be measured.

2. The water level monitoring system of claim 1, wherein the sensor module further comprises:
a low pass filter, connected to the amplifier for filtering the sensed value from the amplifier to reduce noise; and
an analog-to-digital converter, electrically connected to the low pass filter and the processor for converting the sensed value from the low pass filter into a digital format and then sending back to the processor for further calculation.

3. The water level monitoring system of claim 1, wherein the processor is further electrically connected to a communication unit for transmitting sensing information to an external system via network.

4. The water level monitoring system of claim 1, further comprising a temperature sensing module disposed on the load cell and electrically connected to the sensor module, wherein the temperature sensing module comprises:
a sensing unit for sensing an environmental temperature and a temperature of the load cell; and
an amplifier unit, electrically connected to the sensing unit for amplifying values from the sensing unit and then sending back to the processor of the sensor module.

5. The water level monitoring system of claim 4, wherein the sensing unit is a temperature detector.

6. The water level monitoring system of claim 1, wherein the floating unit is further connected with a first floater for extending length of a whole floater.

7. The water level monitoring system of claim 1, wherein the processor is a microprocessor.

8. The water level monitoring system of claim 1, wherein the load cell is disposed atop the floating unit.
